(19) United States
(12) Patent Application Publication
(10) Pub. No.: US 2009/0030736 A1
(43) Pub. Date: Jan. 29, 2009

(54) Method and system for a facility care benefit in an annuity providing lifetime benefit payments

(75) Inventors: Charles D. Tatro, Mendon, MA (US); Jason F. Taylor, New Britain, CT (US); Joseph M. Weiss, Glastonbury, CT (US)

Correspondence Address: WARD & OLIVO, SUITE 300, 382 SPRINGFIELD AVENUE, SUMMIT, NJ, 07901, US

(73) Assignee: HARTFORD FIRE INSURANCE COMPANY

(21) Appl. No.: 11/985,285

(22) Filed: Nov. 14, 2007

Related U.S. Application Data
(60) Provisional application No. 60/961,785, filed on Jul. 24, 2007.

(51) Int. Cl. G06Q 40/00

(52) U.S. Cl. 705/4

(57) ABSTRACT

A method and system provide an annuity contract with a payment base value, a contract value, lifetime benefit payments, and a death benefit, as well as the option of enhanced lifetime benefit payments for a period of time. An insured qualifies for these enhanced lifetime benefit payments when the insured is confined to a nursing home and fails two of six predetermined activities of daily living. The insured retains the option of returning to a lower level of lifetime benefit payments when the enhanced lifetime benefit payments are no longer necessary. The death benefit is reduced by the enhanced lifetime benefit payment withdrawals but the lifetime benefit payment continues to be paid, even if the contract value declines to zero.

### CROSS-REFERENCE TO RELATED APPLICATIONS

This application claims the filing date of U.S. Provisional Application No. 60/961,785, filed Jul. 24, 2007, entitled Method And System For Providing A Facility Care Benefit In An Annuity Providing Lifetime Benefit Payments.

### BACKGROUND OF THE INVENTION

1. Field of the Invention

The present invention relates to a method and system for an annuity providing flexible lifetime benefit payments, with the option of accelerated withdrawal; and more particularly, to a data processing method for administering an annuity contract for a relevant life, the annuity contract having a payment base value, a contract value, and lifetime benefit payments, with the option of enhanced lifetime benefit payments, if the relevant life is confined to a nursing home and fails two of six predetermined activities of daily living.

2. Description of the Prior Art

An immediate annuity is typically used to provide an income stream within a predetermined length of time from the date the premium is received. The amount of income can be either fixed or variable in nature and typically these products do not provide an account value. A deferred annuity is typically used to provide accumulation and, potentially, a future stream of annuity income. The deferred annuity comprises an accumulation period during which the account value will vary with the underlying investments and an annuitization period where the client purchases an immediate annuity with the account value available. Deferred and immediate annuities typically provide guaranteed income for life which transfers some portion or all of the risk of outliving one's accumulated assets to the insurer.

One basis for distinguishing commonly available deferred annuities is whether the annuity is classified as a “fixed annuity” or a “variable annuity”.

In a fixed annuity, the insurer guarantees a fixed rate of interest applicable to each annuity deposit. Therefore, a fixed annuity is desirable for those seeking a “safe” investment. The guaranteed interest rate may apply for a specified period of time, often one year or more. Often, a rate guaranteed for more than one year is called a “multi-year guarantee”. The rate credited on a fixed annuity is reset periodically, moving in an amount and a direction that correlate the yields available on fixed-income investments available to the insurer.

With a variable annuity, the annuity contract owner bears the investment risk. The relevant life typically has a choice of funds in which he/she can direct where the annuity deposits will be invested. The various funds or sub-accounts may include stocks, bonds, money market instruments, mutual funds, and the like.

Variable annuity contracts typically provide a death benefit. Oftentimes during the accumulation period, the death benefit is related to the contract value. That is, if the sub-accounts backing the contract value have performed poorly, then the death benefit may be reduced to an insignificant amount. After annuitization, the death benefit can be a function of the remaining payments of the annuity at the time of the relevant life's death. Further, if the annuity contract does not provide a guarantee (discussed below), the contract will terminate when the contract value goes to zero or some other amount specified in the contract or rider.

Annuity contracts may also provide guarantees in several different variations. A Guaranteed Minimum Death Benefit (GMDB) is a guarantee that provides a minimum benefit at the death of the relevant life regardless of the performance of the underlying investments. A Guaranteed Minimum Income Benefit (GMIB) is a guarantee that will provide a specified income amount at the time the contract is annuitized. The income payment will be dependent on previously stated details set out in the contract. A Guaranteed Minimum Accumulation Benefit (GMAB) is a benefit that guarantees a specified contract value at a certain date in the future, even if actual investment performance of the contract is less than the guaranteed amount. A Guaranteed Minimum Withdrawal Benefit (GMWB) is a guarantee of income for a specified period of time, and in some versions, the income stream is guaranteed for life without requiring annuitization as in the guaranteed minimum income benefit. However, this guarantee will automatically annuitize the contract if the contract value is reduced to zero or some other amount specified in the contract or rider.

Most deferred variable annuity products in the prior art typically determine the amount of the lifetime benefit payments, if any, to be a predetermined percentage (withdrawal percent) of a withdrawal base. The withdrawal base amount is typically set at the time of the first lifetime benefit payment and is fixed for the remainder of the term of the annuity product. Further, the withdrawal percent is typically fixed after the first lifetime benefit payment is requested, or alternatively the withdrawal percent varies slightly for the remainder of the term of the annuity product.

Many financial products and systems have been disclosed. These include the following: annuity value software for determining deferred and immediate annuity contract living contingent and supporting component funding; method and system for determining additional benefits and costs for an annuity contract; providing account values in an annuity with life contingencies; providing loans and/or lines of credit to terminally ill individuals; managing an investment to increase the after-tax death benefit of the investment; administering death benefits; reducing fraud in government benefit programs; issuing, servicing and redeeming capital market products; increasing liquid assets available to at least partially fund living expenses at an assisted living facility; providing retirement income benefits; providing flexible income, liquidity options and permanent legacy benefits for annuities; and determining optimal and tailored lifetime income and death benefit package, Each one of these prior art references suffers from at least the following disadvantage(s): the annuity contract does not provide an opportunity for enhanced lifetime benefit payments if an insured can demonstrate failure to perform at least two of six predetermined activities of daily living and if the insured is confined to a nursing home, wherein the insured may return to the “normal” lifetime benefit payments if they no longer require the enhanced payments.

Accordingly, there remains a need in the art for a data processing method for administering an annuity contract for a relevant life wherein the annuity contract has a guarantee of lifetime benefit payments. In addition, there is needed a data processing method wherein the annuity contract is designed to provide the insured with the option of withdrawing an amount greater than the guaranteed lifetime benefit payment, if the insured is confined to a nursing home and cannot perform a minimum of two of six predetermined activities of daily living. Further, there exists a need for a method of administering an annuity contract for a relevant life, wherein an insured can elect to withdraw an amount greater than the guaranteed lifetime benefit payment for a period of time, and then return to withdrawing an amount equal to the lifetime benefit payment. There further exists a need for a method of administering an annuity contract for a relevant life, wherein the insured can accelerate the insured's death benefit. Additionally, there exists a need for an annuity contract, which provides a withdrawal amount greater than the guaranteed lifetime benefit payment amount, for a period of time, and continues to pay this benefit, even if the contract value has declined to zero.

### SUMMARY OF THE INVENTION

The present invention provides a data processing method, system, and deferred annuity contract with lifetime benefit payments. The lifetime benefit payment amount is based upon a predetermined payment base, which is a function of premium payments. In a preferred embodiment of a variable annuity contract, the premium payments are invested in funds and the contract value is a function of the performance of these funds. The lifetime benefit payment amount is paid to the relevant life regardless of whether the contract value declines to zero.

The insured may elect to accelerate, by a multiple, the lifetime benefit payments, in the event that the insured is confined to a nursing home and fails two of six predetermined activities of daily living. Preferably, the insured must also have fulfilled an elimination period and reached a predetermined age, at least a predetermined number of years after issuance of the policy. The insured may elect to return to withdrawing the “normal” lifetime benefit payment, after a predetermined period of accelerated withdrawals in the form of enhanced lifetime benefit payments.

The invention also provides for a predetermined death benefit. If the insured withdraws an accelerated benefit payment, the predetermined death benefit is reduced, by the amount of the enhanced lifetime benefit payments.

In another aspect, the present invention comprises a data processing system for administering a deferred variable annuity contract having a payment base value, a contract value and lifetime benefit payments, comprising: a storage device; a processor coupled to the storage device, the storage device storing instructions that are utilized by the processor, the instructions comprising: (a) determining a payment base value for the annuity contract; (b) determining a contract value for the annuity contract; (c) determining a death benefit amount; (d) calculating a lifetime benefit payment for the relevant life which decreases both the contract value and the death benefit amount; (e) calculating an enhanced lifetime benefit payment if an insured can demonstrate failure to perform at least two of six predetermined activities of daily living and if the insured requires long-term care; wherein the enhanced lifetime benefit payment is equal to a predetermined multiple times the lifetime benefit payment withdrawal and wherein the death benefit is reduced by an amount equal to the enhanced withdrawal payment without reducing the payment base.

In exchange for paying higher fees, the relevant life receives several advantages by selecting the method and system of the present invention, which provides an enhanced lifetime benefit payment for facility care of the relevant life. These advantages include the following: The amount of the lifetime benefit payments increase when expenses are dramatically increased because of being confined to a nursing home. The enhanced facility care benefits are available to the relevant life without requiring a liquidation of the policy. The enhanced lifetime benefit payments are available within specific guidelines without facing, penalties. The cash flow is able to be provided through enhanced living benefit payments, which therefore reduces the need to invade other assets or investments.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a flow chart illustrating the manner in which a new annuity contract application is processed;

FIG. 2 is a flow chart that illustrates in more detail the manner in which an annuity contract is established;

FIG. 3 is a flow chart that illustrates in more detail the manner in which an account value is set up;

FIG. 4 is a flow chart that illustrates in more detail the manner in which customer communication is established;

FIG. 5 is a flow chart illustrating the appropriate steps after a withdrawal is requested;

FIG. 6A is the first page of a spreadsheet illustrating the calculations of the invention in accordance with an embodiment of the present invention;

FIG. 6B is the second page of a spreadsheet illustrating further calculations of the invention in accordance with an embodiment of the present invention;

FIG. 6C is the third page of a spreadsheet illustrating additional calculations of the invention in accordance with an embodiment of the present invention;

FIG. 7A is the first page of a flow chart illustrating a data processing method for administering an annuity product with a facility care benefit feature in accordance with an embodiment of the present invention;

FIG. 7B is the second page of a flow chart illustrating a data processing method for administering an annuity product with a facility care benefit feature in accordance with an embodiment of the present invention;

FIG. 7C is the third page of a flow chart illustrating a data processing method for administering an annuity product with a facility care benefit feature in accordance with an embodiment of the present invention;

FIG. 8 is a diagram illustrating the system on which the present invention is implemented in accordance with an embodiment of the present invention;

FIG. 9 depicts a table illustrating lifetime benefit payments as a function of age for an annuity providing a facility care benefit in accordance with an embodiment of the present invention; and

FIG. 10 depicts a graph illustrating lifetime benefit payments as a function of age for an annuity providing a facility care benefit in accordance with an embodiment of the present invention.

### DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. They are deemed to afford the best embodiment for purposes of disclosure; but should not be construed as limiting the scope of the invention. The following presents a detailed description of the preferred embodiment of the present invention.

As used herein, the term “annuity contract” means a set of rules and other data that are reflected in a computer processing system for operations of the annuity product.

As used herein, the term “relevant life” means any one or more of the following: an owner, joint owner, annuitant, joint annuitant, co-owner, co-annuitant or beneficiary.

The present invention comprises a data processing system and method for administering an annuity contract containing a facility care benefit feature. The system, method, and contract provide the client with both the benefit of a periodic lifetime benefit payment as well as the opportunity to accelerate this lifetime benefit payment, in the form of an enhanced lifetime benefit payment when needed. According to the invention, the facility care benefit insures that if the client fulfills certain conditions, such as a ten year wait and an 180 day elimination period, and the client is confined to a nursing home and fails at least two of six predetermined activities of daily living, the client can elect an enhanced lifetime benefit payment that is equal to a predetermined multiple times the lifetime benefit payment. In one embodiment, the predetermined multiple is three.

It is known that for people who move from their own homes to a nursing home, mortality rates are high. In fact, 50-60% of people admitted to such homes die within the first two years and mortality rates are highest in the first six months. A patient's ability to bathe, dress, eat, move from place to place, contain urine and stool, and ambulate independently to the bathroom is strongly related to the patient's prognosis. As a patient becomes unable to perform these activities of daily living, the patient's prognosis worsens.

Nursing homes are expensive and costs continue to rise. According to a recent survey from the MetLife Mature Market Institute, a day in a nursing home costs $203 on average in the U.S., which is up 5.7% from last year's cost of $192. The average stay in a nursing home is 2.4 years, for a total average cost of $177,828. Even a short stay in a nursing home is costly.

The present invention addresses the need for short-term access to funds to help pay for nursing home care. The insured need no longer fear that admission to a nursing home will deplete the insured's estate or that the insured will need to rely on the financial support of the insured's children. The insured need only elect the enhanced lifetime benefit payments available through the facility care benefit rider to meet the insured's needs. If the insured recovers, the insured may elect to return to the standard lifetime benefit payment.

Enhanced lifetime benefit payments only deplete the insured's death benefit. Enhanced lifetime benefit payments do not lower the payment base, which preferably determines the amount of the lifetime benefit payment. The payment base is only reduced when the insured withdraws more than the specified lifetime benefit payment amount allocated under the contract. In one embodiment, the payment base can also be increased or stepped up by a percent, usually not more than ten percent annually, in response to growth of the contract value because of performance of the sub-accounts. The payment base does not fluctuate as much as the account value, which more closely reflects the rate of return on investment of the premium.

In another embodiment, the present invention comprises a system for administering a deferred variable annuity contract during the accumulation phase for a relevant life, the annuity contract having a payment base value, a contract value, and lifetime benefit payments, comprising: a storage device; a processor coupled to the storage device, the storage device storing instructions that are utilized by the processor, the instructions comprising: (i) receiving information from a relevant life in order to establish the deferred variable annuity contract: (ii) determining a payment base value for the annuity contract; (iii) determining a contract value for the annuity contract; (iv) an instruction for determining a death benefit amount; (v) receiving lifetime benefit payment withdrawal requests from the relevant life; (vi) calculating a lifetime benefit payment for the relevant life which decreases both the contract value and the death benefit amount; (vii) calculating an enhanced lifetime benefit payment if an insured can demonstrate failure to perform at least two of six predetermined activities of daily living and if the insured requires long-term care; wherein the enhanced lifetime benefit payment is equal to a predetermined multiple times the lifetime benefit payment withdrawal and wherein the death benefit is reduced by an amount equal to the enhanced withdrawal payment without reducing the payment base.

It should be understood that as used herein the term “periodically” includes method steps that in certain aspects may only be performed once. In other aspects, such “periodically” performed method steps may be performed more than once as described herein.

The following definitions are given hereunder to better understand terms used in the specification.

“Relevant Life” or “Covered Life”: The term relevant life or covered life is the governing life for determination of the living benefits provided under this illustrative embodiment. Covered life (or relevant life) may refer to any one or more of the following: an owner, joint owner, annuitant, joint annuitant, co-owner, co-annuitant or beneficiary.
“Withdrawal Base”: The withdrawal base is the amount used in one embodiment of the present invention to determine the lifetime benefit payment. Preferably, the withdrawal base may be equal to the amount of the original premium, the payment base value, the contract value, or the greater of the payment base value and the contract value.
“Payment Base”: The payment base (PB) (or more accurately the payment base value) is the amount used in one embodiment of the present invention to determine the lifetime benefit payment and the rider charge. In one embodiment of the present invention, the initial payment base value equals the initial premium.
“Premium”: 100% of the dollar amount of the initial or subsequent premium payments deposited into the contract before application of any sales charges or payment enhancements.
“Withdrawal Request”: A request made by the relevant life to withdraw funds during the “accumulation phase” of the contract. One type of withdrawal is a lifetime benefit payment. Any withdrawal that is in excess of the lifetime benefit payment may: (i) decrease the contract value below the minimum contract value; (ii) decrease the payment base value; and (iii) decrease the guaranteed death benefit.
“Lifetime Benefit Payment”: A benefit payment that is available until the death of the relevant life. The lifetime benefit payment may be paid yearly in one embodiment. The total lifetime benefit payment for the year may also be distributed monthly, quarterly or any other defined period. Preferably, the lifetime benefit payment is only available if the covered life age is 60 (or other predetermined age) or older. Preferably, if the relevant life is age 59 (or other predetermined age) or younger, the LBP is equal to zero. Other age restrictions can also be utilized for the lifetime benefit payment.
“Contract Value”: The contract value (CV) is a numerical measure of the relative worth of a variable annuity product during the accumulation phase. The contract value is determined by adding the amount of purchase payments made during the accumulation phase, deducting management fees, deducting contract fees, deducting optional rider fees and surrenders made by the owner, and adjusting for the relative increase (or decrease) of the investment option(s) chosen by the owner. It should be understood that in other embodiments of the present invention, other formulas may be utilized for determining the contract value.
“Sub-account”: Variable account investments within the variable annuity contract, such as mutual funds, stocks and bonds.
“Withdrawal”: Also known as “surrender”, a relevant life may withdraw up to the contract value at any time.
“Death Benefit”: The death benefit provision guarantees that upon the death of the relevant life a death benefit (DB) is paid to a beneficiary named in the contract that is equal to the greater of the guaranteed death benefit or the contract value as of the date the annuity company receives due proof of death. It should be understood that in other embodiments of the present invention, other formulas may be utilized for determining the guaranteed death benefit.
“Benefit Amount”: In one embodiment of the present invention, the benefit amount is used to calculate that amount of the death benefit. Preferably, the benefit amount is equal to the premium payments minus any lifetime benefit payments or withdrawals.
“Annuity Commencement Date”: The annuity commencement date (ACD) is the date upon which the contract enters the “annuitization phase”.
“Withdrawal Percent”: In one embodiment of the present invention, the withdrawal percent (WP) is used to determine the amount of the lifetime benefit payment. It should be understood that in other embodiments of the present invention, other formulas may be utilized for determining the lifetime benefit payment.
“Step-Up”: An increase to the payment base value that is available if the contract value increases because of favorable performance of the underlying investments. Preferably, the step-up is guaranteed at a predetermined percentage.
“Annuity Contract”: The term annuity contract means a set of rules and other data that are reflected in a computer processing system for operations of the annuity product.
“Issue Rules”: The issuance of a contract may be subject to established requirements known as issue rules.

The following detailed illustrative embodiment(s) is presented to provide a more complete understanding of the invention. The specific techniques, systems, and operating structures set forth to illustrate the principles and practice of the invention may be embodied in a wide variety of sizes, shapes, forms and modes, some of which may be quite different from those in the disclosed embodiment. Consequently, the specific structural and functional details disclosed herein are exemplary. They are deemed to afford the best embodiment for purposes of disclosure; but should not be construed as limiting the scope of the invention.

### Covered Life in Single and Joint/Spousal Election(s)

The covered life, or relevant life, may have a single life election or joint/spousal continuation election as described more fully herein.

### Single Life Election:

If a natural owner, the covered life is the owner and the joint owner (if any) on the rider effective date. If a non-natural owner, the covered life is the annuitant on the rider effective date. All age-contingent benefit provisions are based on the attained age of the oldest covered life.

### Joint/Spousal Continuation Election:

If a natural owner, the covered life is both spouses (as defined by Federal Law). All age-contingent benefit provisions are based on the attained age of the youngest covered life.

### Issues Rules

Issue rules are set forth to provide a more complete understanding of this illustrative embodiment of the present invention. It should be understood by those skilled in the art that these issue rules are set forth for illustrative purposes only and that other rules may be utilized. Accordingly, the issue rules set forth below should not be construed as limiting the scope of the invention.

The issue rules are rules that apply to the annuity contract. The issue rules may include a maximum issue age. The riders are not available if any covered life or annuitant is age 81 (or other predetermined age) or greater on the rider effective date. In another embodiment, the riders are not available if any covered life or annuitant is age 76 (or other predetermined age) or greater on the Rider effective date. The rider may be elected on contract issue or post-issue.

Single Life Election: No additional requirements
Joint/Spousal Continuation Election: (This may also include co-annuitants)
One of the following must apply:
If a natural owner purchases Joint/Spousal election, and adds a spousal joint owner, then the owner can name anyone else as the designated beneficiary, because by contract disposition, the joint owner will receive the death benefit.
If a natural owner purchases joint/spousal election, and does not add a joint owner, then the owner must name their spouse as the designated beneficiary.
If a non-natural owner purchases joint/spousal election, then the annuitant's spouse must be the designated beneficiary.
A joint owner who is not the owner's spouse is not allowed.

### Calculation of the Withdrawal Percent (WP)

The Withdrawal Percent (WP) is used to determine the amount of the lifetime benefit payment. There are two types of withdrawal percents: (i) the predetermined withdrawal percent (shown below); and (ii) the withdrawal percent elected by the relevant life during each given year.

The WP is determined at the later of, (i) the attained age of the covered life on the most recent contract anniversary prior to the first withdrawal, or (ii) the contract anniversary immediately following the covered life's 60^{th} birthday (or other predetermined age).

### Single Life Election:

(Note: the following percentages and ages, if ages are in fact used, can vary)

5.0% for attained ages 60 to 64;

5.5% for attained ages 65 to 69;

6.0% for attained ages 70 to 74;

6.5% for attained ages 75 to 79; and

7.0% for attained ages 80 and above.

### Joint/Spousal Continuation Election.

4.5% for attained ages 60 to 64;

5.0% for attained ages 65 to 69;

5.5% for attained ages 70 to 74;

6.0% for attained ages 75 to 79; and

6.5% for attained ages 80 and above.

### Calculation of the Payment Base (PB)

The Payment Base (PB) (or more accurately payment base value) is the amount used to determine the lifetime benefit payment (LBP) and the rider charge.

If this rider is effective on the contract issue date, then the PB equals the X % of the initial premium. If this rider is effective after the contract issue date, then the PB equals 100% of the dollar amount of the contract value on the rider effective date, less any payment enhancements received in the last twelve months.

When subsequent premium payments are received, the PB will be increased by 100% of the dollar amount of the subsequent premium payment. Periodically accepting premium payments from the relevant life will increase the payment base, the guaranteed death benefit amount and the contract value.

### Calculation of the Enhanced Lifetime Benefit Payment

The insured may elect to accelerate the lifetime benefit payments. The enhanced LBPs may be requested if the insured is confined to a nursing home and cannot perform a minimum of two of six predetermined activities of daily living, fulfills an elimination period requirement and reaches a predetermined age. In other embodiments of the invention, the enhanced lifetime benefit payment may be dependent upon the following requirements: (i) the relevant life reaches a predetermined or specified age (i.e., seventy years old); and (ii) ten years have passed since the issue date of the contract.

It is important to note that, in alternative embodiments, the maximum total withdrawal percent for a given payout period is not established by any specific formula, but rather is predetermined and is an arbitrary number. The above steps are repeated for each subsequent payment period.

### Contingent Deferred Sales Charge (CDSC)—Free Up to the Amount of the LBP

If the LBP exceeds the actual withdrawal amount (AWA) on the most recent contract anniversary, any contingent deferred sales charge (CDSC) will be waived up to the LBP amount.

### Death Benefit Before Annuity Commencement Date

For both single and joint/spousal election, a death benefit may be available on the death of any owner or annuitant. The death benefit provision guarantees that upon death a death benefit (DB) will be paid equal to the greater of the death benefit or the contract value as of the date proof of death is received. The rider charge is not assessed on death.

When proof of death is processed, the contract will go into suspense mode. No charges will apply during that period. The amount available to be paid as a death benefit under the terms of the rider is a return of premium adjusted for subsequent premium payments and partial surrenders.

When a subsequent premium payment is received, the DB will be increased by 100% of the dollar amount of the subsequent premium payment. If the withdrawal feature is revoked, all future withdrawals from the death benefit will be fully proportional as of the date it is revoked.

When calculating a death benefit for a beneficiary, the death benefit is the greater of (i) a predetermined death benefit amount; and (b) the present contract value, unless an enhanced lifetime benefit payment has been made, in which case the death benefit is equal to the predetermined death benefit minus the enhanced lifetime benefit payments.

### Contract Value (CV) Reduces Below Minimum Account Rules

The minimum contract value rules are an optional feature of the present invention and do not apply to the preferred embodiments. If the minimum contract value rules are selected to be applied, then the following rules are used. The minimum contract value (MCV) is defined as 20% or other predetermined percentage of the payment base on the date of a withdrawal request. Lifetime benefit payments cannot reduce the contract value below this minimum threshold. Only sub-account performance and withdrawals in excess of the LBP can decrease the contract value below the MCV.

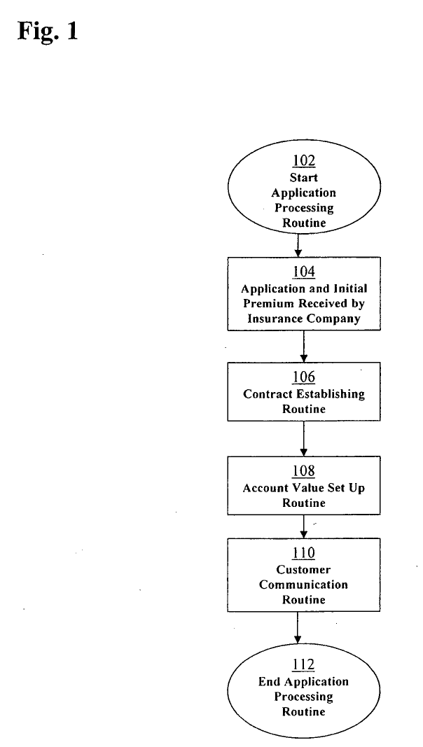

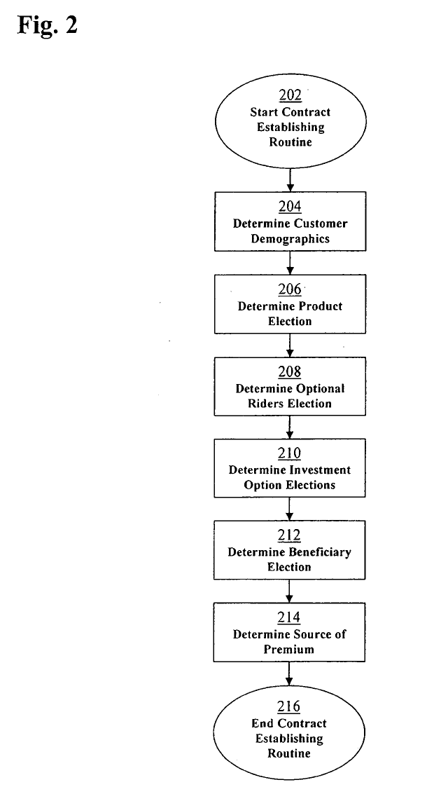

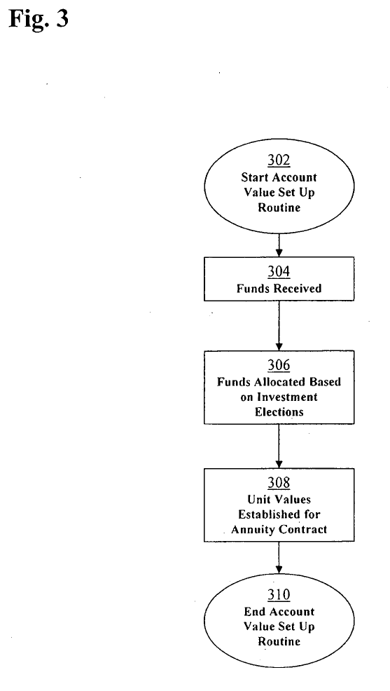

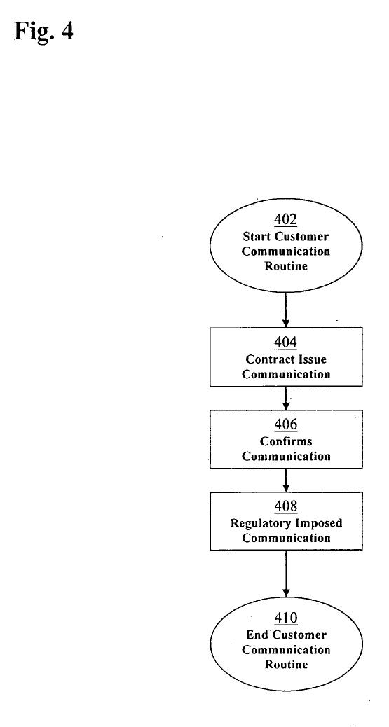

Turning now to the figures, FIG. 1 illustrates the manner in which a new annuity contract application is processed. The new application processing routine starts (block 102) when an application is completed. The annuity contract application and initial premium are received by the insurance company (block 104). The annuity contract is then established through the contract establishing routine (block 106) as further described in FIG. 2. After the annuity contract is established, the account value is then set up through the account value set routine (block 108), via the computer systems, as further specified in FIG. 3. Thereafter customer communication is established through the customer communication routine (block 110) as further specified in FIG. 4. The application processing routine ends at (block 112).

FIG. 2 is a flow chart that illustrates in more detail the manlier in which an annuity contract is established. The annuity contract establishing routine starts at (block 202). After receiving the annuity contract application, customer demographics are determined (block 204). The customer demographics and other data from the annuity contract application are transmitted to the insurance company by any suitable means, such as electronic transmission, facsimile transmission, telephonic transmission, and the like. The customer demographics may be scanned in or electronically entered into the computer system by the insurance company after the demographic data is determined. Such demographic information may include age, gender, date of birth, social security number, address, marital status, and the like. The customer demographics may be used for a variety of purposes, such as identification purposes or to locate a relevant life by searching his/her social security number. The customer demographics are also used when determining and/or calculating a variety of factors that are related to the annuity contract, such as benefit amount calculations, tax considerations, and the like. The types of customer demographics that are determined are generally related to the type of annuity contract application that is filled out by the relevant life. The specific product election is determined (block 206). For example, the specific product may be elected from a group of different variable annuity products, which each have different characteristics including the costs and fees as well as the liquidity features associated therewith. The election of optional riders is determined (block 208). For example, the optional riders may be elected from a group of different riders, which each have various guaranteed withdrawal features. The election of investment options is determined (block 210). For example, the investment options include money market funds, bond funds, stock funds, and the like. The beneficiary is elected (block 212). In one aspect, this is the person who will collect the death benefits, if any. The source of the premium is determined (block 214). For example, the source of the premium may come from the relevant life's personal funds or may come from another annuity in the form of a transfer. It should be understood that the steps taken for establishing the contract may proceed in various orders and that the order shown in FIG. 2 is for illustrative purposes only and is only one embodiment of said steps. The contract establishing routine ends at (block 216).

FIG. 3 is a flow chart that illustrates in more detail the manner in which an account value is set up. The account value set up routine starts at (block 302). The funds are received (block 304). For example, the funds may be received via electronic transfer from a bank account or from another variable annuity holder. The funds are then allocated based on investment elections (block 306). For example, the allocations can be accomplished through a computerized system according to the investment elections by the relevant life. Unit values are established for the annuity contract (block 308). For example, based on the performance of the underlying investment elections, unit values are established, preferably oil a daily basis, for use in determining the resulting impact on the relevant life's annuity contract based on their specific fund allocations. For example the number of units that are applied to each annuity contract is different for each relevant life based on the number of units held within the annuity contract. It should be understood that the steps taken for setting up the account value may proceed in various orders and that the order shown in FIG. 3 is for illustrative purposes only and is only one embodiment of said steps. The account value set up routine ends at (block 310).

FIG. 4 is a flow chart that illustrates in more detail the manner in which customer communication is established. The customer communication routine starts at (block 402). Communications with the customer may be accomplished via email, facsimile, letter, telephone, and the like. Communication with the customer in one aspect relates to the issuing of the contract (block 404). Communication with the customer in one aspect relates to the relevant confirmation of the previous contract issuance communication (block 406). Any regulatory-imposed communication with the client is accomplished (block 408). It should be understood that the steps taken for establishing customer communication may proceed in various orders and that the order shown in FIG. 4 is for illustrative purposes only and is only one embodiment of said steps. The customer communication routine ends at (block 410).

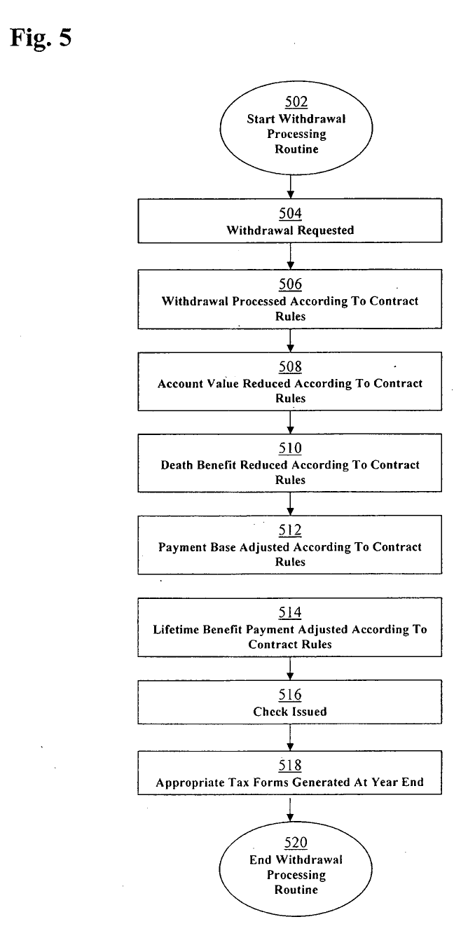

FIG. 5 is a flow chart illustrating the appropriate steps after a withdrawal is requested. The withdrawal processing routine starts at (block 502). A withdrawal is first requested by the relevant life at (block 504). The withdrawal is then processed according to the contract rules (block 506). The contract rules are embedded in a computer system or the like and vary according to the type of annuity contract. For example, in certain embodiments, a requested withdrawal amount by the relevant life may be limited by the contract rules to a specific withdrawal percent that is applied by the computer system, and wherein the contract rules specify the withdrawal percent according to the age of the relevant life or the number of years since the contract was established. Therefore, the contract rules govern the data flow in the computer system. The contract rules are administratively built into the computer system to obviate the need for manual intervention by the insurance company. The account value is reduced according to the contract rules (block 508). The death benefit is reduced according to the contract rules (block 510). The withdrawal benefit is adjusted according to the contract rules (block 512). The check or other form of payment is issued (block 516). The appropriate tax forms are generated at year end (block 518). It should be understood that the steps taken for processing withdrawals may proceed in various orders and that the order shown in FIG. 5 is for illustrative purposes only and is only one embodiment of said steps. The withdrawal processing routine ends at (block 520).

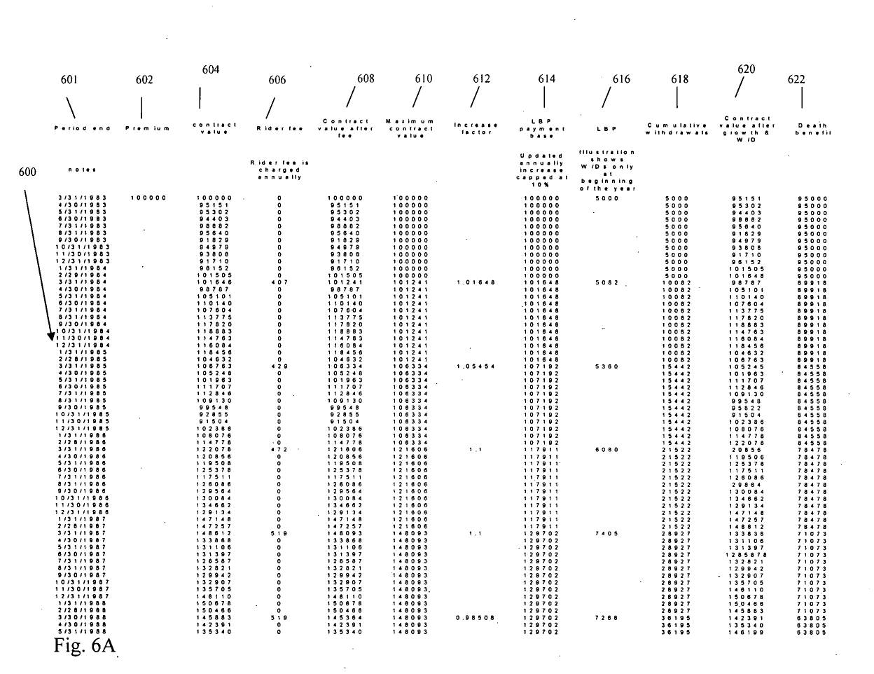

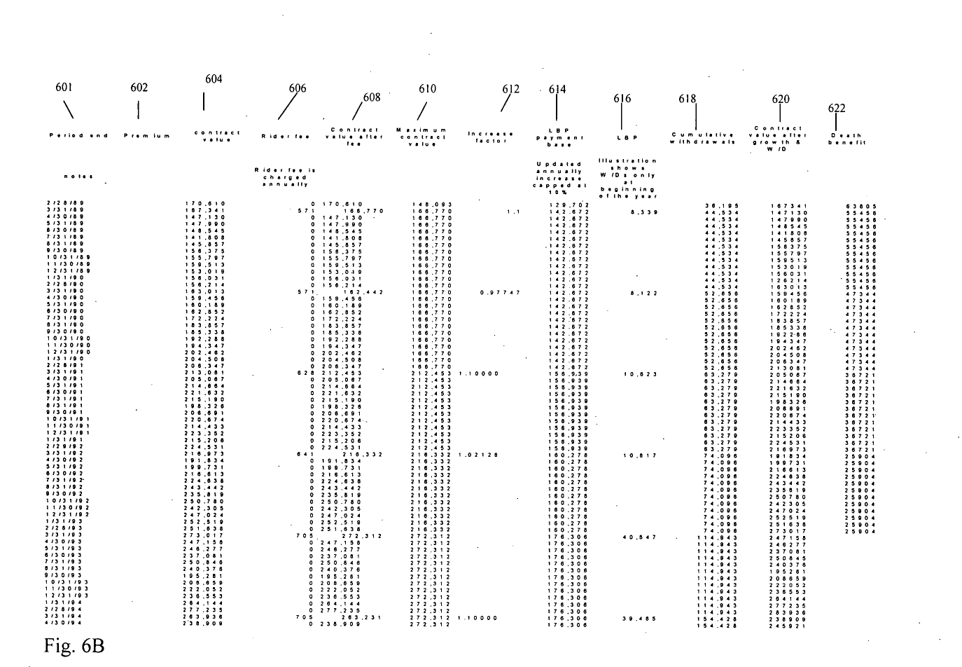

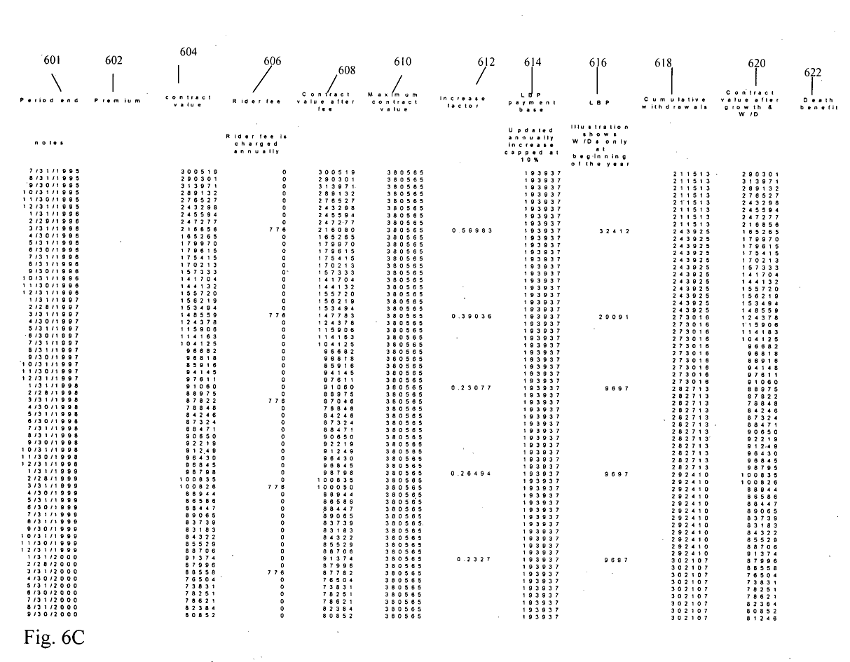

FIGS. 6A, 6B, and 6C illustrate how the enhanced lifetime benefit payments are implemented in accordance to an embodiment of the present invention. Turning to FIG. 6A, column 1, period end 601 illustrates the date in which the period for a specific cycle has ended. Column 2, premium 602, is typically a value such as $100,000 and represents the insured's payment to the insurance company for coverage under the policy. premiums 602 are generally paid annually. Column 3, contract value 604, represents the dollar value of the policy and is determined by the growth of the investments in which the premium is invested. Contract value 604 may rise above the initial value of the premium 602 invested or fall below this initial value. Column 4, the Rider Fee 606, represents the extra fee for options such as the facility care benefit and is typically an amount such as 0.4% of the respective premium amount 602. Column 5, contract value after fee 608, represents the contract value after rider fee 606 has been subtracted from the original contract value 604.

Column 7, the increase factor 612, represents a multiple applied to the respective contract value 604, when the underlying investments increase in value. A typical increase factor 612 is 1.01648. Column 6, the maximum contract value 610 is calculated as the greater of respective contract value 604 at year end, after the corresponding rider fee 606 is deducted, and the maximum contract value 610 before the respective increase factor 612 is applied. Column 8, the LBP payment base 614 is a value initially equal to the corresponding contract value 604, but thereafter, the value is multiplied by the respective increase factor 612 if increase factor 612 is greater than 1. The LBP payment base 614 is updated annually and preferably capped at a maximum of 10%. The LBP payment base 614 is a tracked number used for calculating the amount of the guaranteed payment to the insured. The LBP 616, represented by column 9, is the guaranteed lifetime benefit payment issued to the insured. LBP 616 is typically equal to 5% of the respective LBP Payment Base 614, paid annually. However, it can be increased by a benefit percent, such that the LBP is equal to a maximum of 3 times the initial lifetime benefit payment 616.

Column 10, cumulative withdrawals 618, represents the insured's withdrawals. Withdrawals are deducted from both the contract value 604 and the death benefit 622, which is illustrated in column 12. Even when contract value 604 and death benefit 622 have declined to zero, the lifetime benefit payment 616 continues to be paid. At this point, the insured is paid from the claims portion of the contract. Conversely, if the insured dies before the premium has been paid out completely, the contract continues to pay an annuity. Column 11, contract value after growth and withdrawal 620 represents the value of the contract after the growth has been added to the contract value and after the withdrawal has been subtracted from the contract value.

The values, specific amounts, multiples, and percentages appearing in the table are merely exemplary and are strictly for illustration purposes only. Accordingly, they may vary from one embodiment and contract to another.

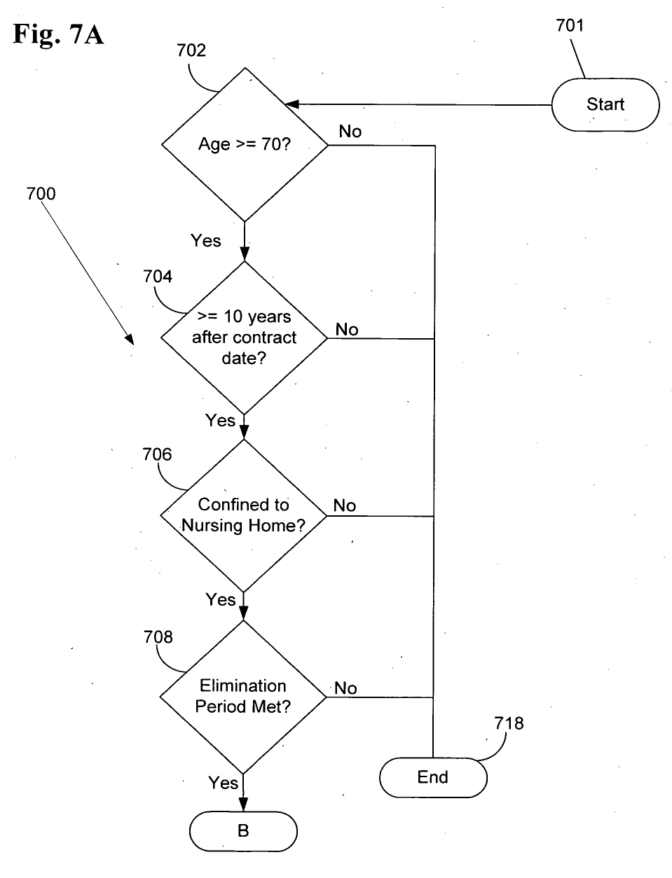

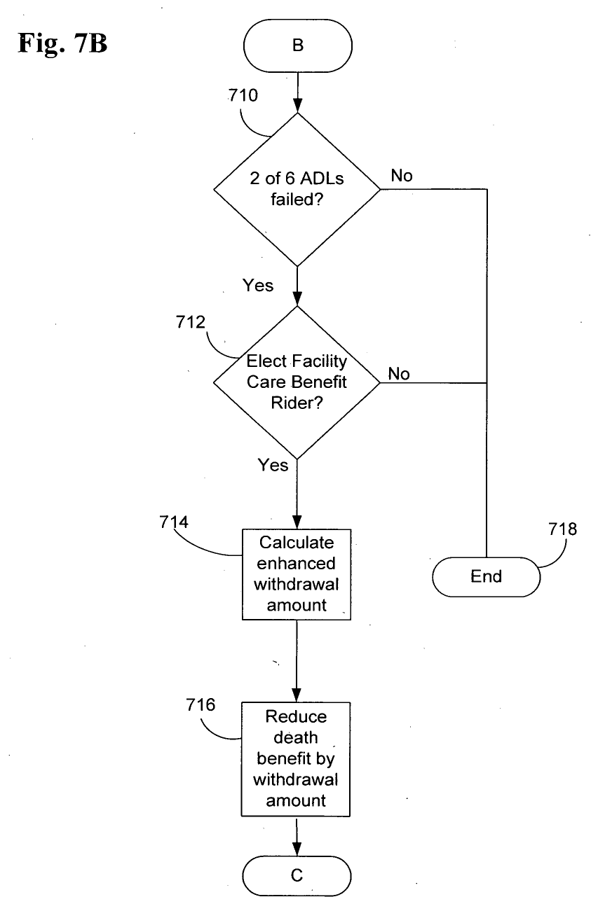

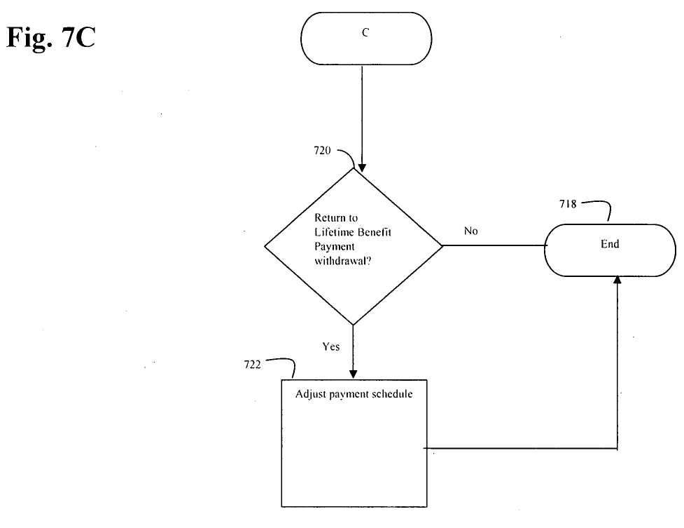

FIGS. 7A, 7B, and 7C depict a flow chart 700, illustrating an embodiment of the present invention comprising a data processing method for administering an annuity contract. The present method starts at (block 701). Method steps at (blocks 702, 704, 706, 708, and 710) test to see whether the relevant life meets specific criteria. If not, the relevant life is not eligible for the facility care benefit rider and the method ends at (block 718). Specifically, in one embodiment, at (block 702), the method tests to see whether the relevant life has reached the age of 70; at (block 704), the method tests to see whether at least ten years have passed since initiation of the contract; at (block 706), the method test to see if the relevant life is confined to a nursing home; at (block 708), the method tests to see if an elimination period, typically of 180 days, has been net (the elimination period can overlap with the ten year wait period); at (block 710), the method tests to see whether the relevant life has failed at least two of the six predetermined activities of daily living. If the relevant life passes all of the preceding tests, the relevant life is eligible for the facility care benefit rider.

In an alternate embodiment, the wait period and the age limit are adjustable. In another embodiment, if the relevant life has not reached the age of 70, but is willing to pay a penalty, the method may proceed to the next step. In yet another embodiment, the relevant life may qualify for the rider if the relevant life is confined to a variety of long term care facilities, such as an assisted living facility or rehabilitation facility.

If the relevant life meets all the above-identified requirements, then the relevant life becomes eligible to elect the facility care benefit rider (block 712). If the relevant life decides to elect the facility care benefit rider, a maximum enhanced lifetime benefit payment amount is calculated equal to three times the guaranteed lifetime benefit payment (block 714). In an alternate embodiment, this amount may vary. The death benefit is reduced by the enhanced lifetime benefit amount the relevant life withdraws at (block 716).

Upon the termination of the enhanced lifetime benefit payments, the relevant life can elect to return to the standard guaranteed lifetime benefit payments (block 720). Thus, the payment schedule is adjusted to return to the standard benefit payment amount (block 722) and the process ends at (block 718).

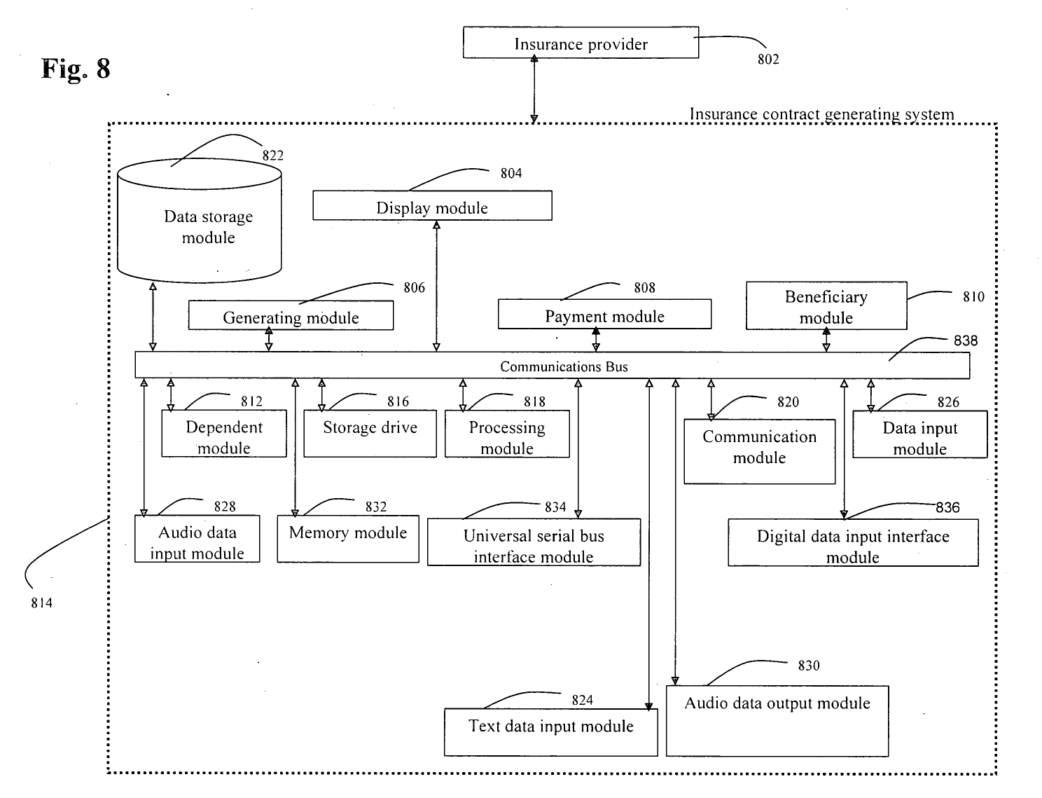

Referring next to FIG. 8, depicted is a preferred embodiment of a system on which the methods of the present invention may be implemented. In one example of the preferred embodiment, the insurance contract generating system 814 would generally be used by an insurance provider 802, however the system may be operated by any individual or organization offering an insurance product as outlined in the present specification without departing from the spirit of the present invention. System 814 may be implemented in many different ways such as part of a single standalone server or as a network server or servers, which may be distributed across multiple computing systems and architectures. Preferably, the central processing computer or network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server.

The network server may also be configured in a distributed architecture, wherein the server components or modules are housed in separate units or locations. Each of the modules described may be implemented as single servers or one or more or all of the modules may be incorporated into a single server. These servers will perform primary processing functions and contain at a minimum, a RAM, a ROM, and a general controller or processor. In such an embodiment, each server is connected to a communications hub or port that serves as a primary communication link with other servers, clients or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

In the preferred embodiment, all of the modules described herein are operably inter-connected via a central communications bus 838. The communications bus 838 is able to receive information from each of the modules, as well as to transmit information from one module to another. The insurance contract generating system 814 further includes a display module 804, and a generating module 806. The generating module is used for generating an insurance contract, wherein the insurance contract provides coverage to an individual or group for at least one event defined in the insurance contract.

The insurance contract generating system 814 additionally includes a payment module 808 for making payments to an insured individual or group for a predetermined period of time as defined by the deferred annuity insurance contract.

The system further comprises a beneficiary module 810 for choosing a beneficiary to receive payments from the insurance provider in the instance of an insured individual's death. Furthermore, the system comprises a dependent module 812 for offering an insurance contract structured according to the methods of the present invention to dependents of an individual eligible for the insurance contract described herein.

Additionally, the insurance contract generating system 814 includes: a storage drive 816 for receiving data stored on a storage disc, a processing module 818 for processing digital data received by and contained in the insurance contract generating system 814, a communication module 820 for bi-directional communication with external and telecommunications systems, a data storage module 822 for storing and managing digital information, a text data input module 824 for inputting data in the form of text, and a data input module 826 for converting to digital format documents and images and inputting them into the insurance contract generating system 814.

Finally, the insurance contract generating system 814 includes: an audio data input module 828 for receiving and inputting audio information, an audio data output module 830 for Outputting data in audio format (i.e. recorded speech, synthetically generated speech from digital text, etc), a memory module 832 for temporarily storing information as it is being processed by the processing module 818, a universal serial bus interface module 834 for receiving and transmitting data to and from devices capable of establishing a universal serial bus connection, and a digital data input interface module 836 for receiving data contained in digital storage devices.

Data storage device may include a hard magnetic disk drive, tape, optical storage units, CD-ROM drives, or flash memory. Such data storage devices generally contain databases used in processing transactions and/or calculations in accordance with the present invention. In one embodiment, the database software creates and manages these databases. Insurance-related calculations and/or algorithms of the present invention are stored in storage device and executed by the CPU.

The data storage device may also store, for example, (i) a program (e.g., computer program code and/or a computer program product) adapted to direct the processor in accordance with the present invention, and particularly in accordance with the processes described in detail hereinafter with regard to the controller; (ii) a database adapted to store information that may be utilized to store information required by the program. The database includes multiple records, and each record includes fields that are specific to the present invention such as interest rates, contract value, payment base value, step-up, premiums, subscribers, payouts, claims, etc.

The program may be stored, for example, in a compressed, all uncompiled and/or all encrypted format, and may include computer program code. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as providing a deferred annuity insurance contract to an individual, generating a deferred annuity insurance contract, and making payments to the individual as defined in the deferred annuity insurance contract. The functions described above are merely exemplary and should not be considered exhaustive of the type of function, which may be performed by the computer program code of the present inventions.

The computer program code required to implement the above functions (and the other functions described herein) can be developed by a person of ordinary skill in the art, and is not described in detail herein.

The term “computer-readable medium” as used herein refers to any medium that provides or participates in providing instructions to the processor of the computing device (or any other processor of a device described herein) for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read. Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

For example, a user provides instructions for the amount of the living benefit payment that is requested. It should be understood that the user may communicate with the computing system directly or indirectly through another party, such as the insurance provider 802. In the event the user communicates with an insurance provider 802, the insurance provider 802 receives and transfers information, to and from the insurance contract generating system 814 via the text data input module 824, audio data input module 828, audio data output module 830 and the display module 804. As used herein the data storage module 822 is also referred to as a storage device. The processing module 818 is contained within the insurance contract generating system 814, which is coupled to the storage device, the storage device stores instructions that are utilized by the processor. The instructions preferably comprise: (i) an instruction for establishing a contract value while maintaining a lifetime benefit payment; (ii) an instruction for paying an enhanced lifetime benefit payment when, (a) an insured is able to demonstrate failure to perform at least two of six predetermined activities of daily living and (b) the insured requires long-term care; whereby a distribution of funds from the insured's account is accelerated by reducing a predetermined death benefit.

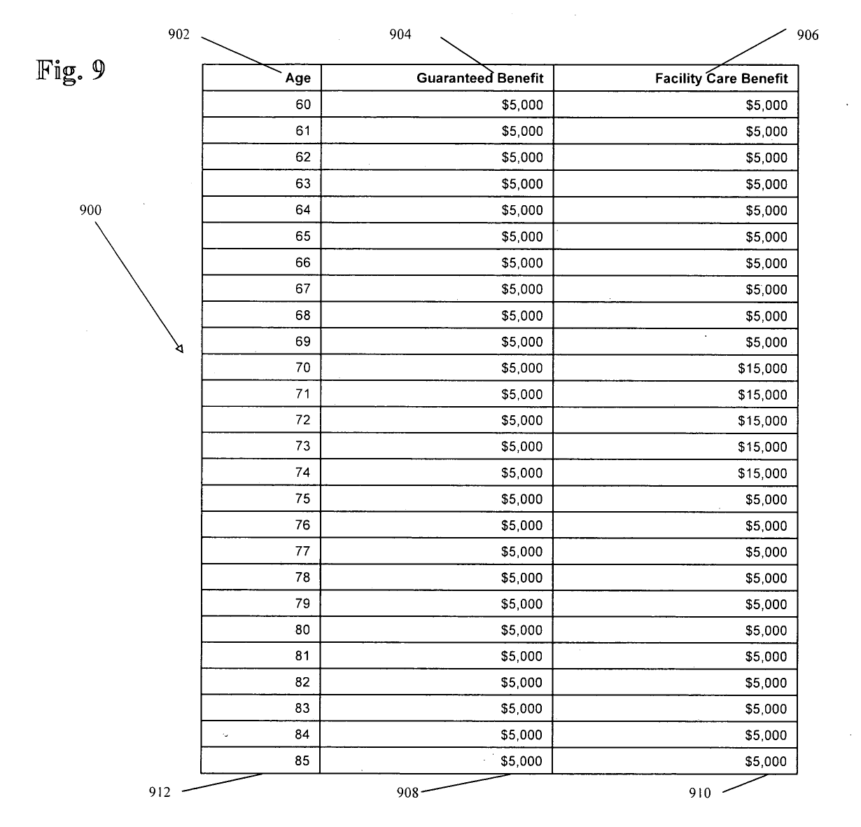

FIG. 9 depicts a table 900, which illustrates lifetime benefit payments 908 and 910 as a function of age for an annuity providing a facility care benefit. In this example, the initial investment is $100,000 (not shown). Furthermore, it is important to note that table 900 illustrates hypothetical lifetime benefit payments 908 and 910 for the annuity contract strictly for the purposes of illustration, thus, lifetime benefit payments 908 and 910 should not serve to limit the scope of the present invention. “Age” column 902 tracks the age 912 of the relevant life. Once again, it is important to note that ages 912 as illustrated by table 900 are merely exemplary and thus are strictly for the purposes of illustration. “Guaranteed Benefit” column 904 illustrates the “normal” or “guaranteed” lifetime benefit payments 908 under the annuity contract determined by a hypothetical withdrawal percent of 5% (not shown) and a payment base of $100,000. “Facility Care Benefit” column 906 illustrates the enhanced lifetime benefit payments 910 that are elected by the relevant life starting at age 70 and proceeding for 5 consecutive years until finally terminating. In a preferred embodiment of the present invention, the enhanced lifetime benefit payments 910 are only allowed to be taken for 5 consecutive years. Starting at age 75, the payments 910 revert back to the “normal” lifetime benefit payments 910 as illustrated. In the example illustrated by FIG. 9, the payment base does not change from its original value because there are no additional premium payments and there are no withdrawals in excess of the lifetime benefit payments. Therefore, in the example, the present payment base is always equal to the original payment base.

However, it should be noted that in some situations the payment base value will change over time from its original value; preferably, the relevant value of interest in the present invention is therefore the present payment base, not the original payment base. In another embodiment, the original payment base is used for the selection of the withdrawal base. The formula used to calculate the lifetime benefit payment amounts in this example is: Lifetime Benefit Payment=Withdrawal Percent×Withdrawal Base, wherein for this example the Withdrawal Percent is 5%.

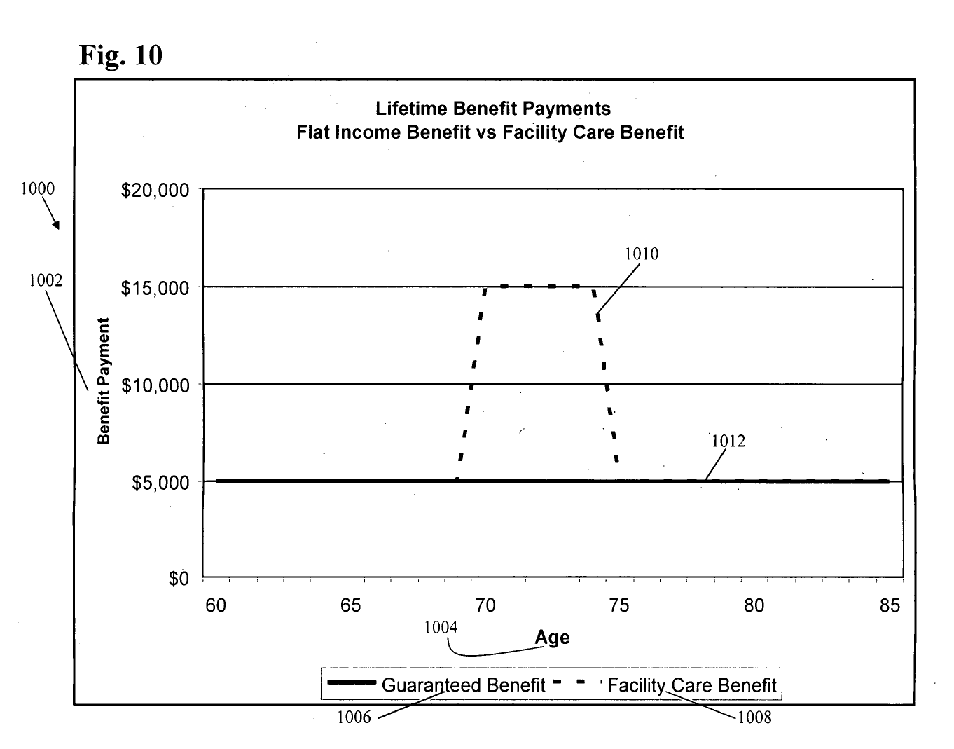

FIG. 10 depicts a graph 1000 titled, “Lifetime Benefit Payments—Flat Income Benefit vs Facility Care Benefit”, which further illustrates the effects of the facility care benefit of the present invention and directly corresponds to the data illustrated by table 900. More specifically, graph 1000 includes “Benefit Payment” scale 1002, which illustrates benefit payments 1010 and 1012 as a function of age 1004 for differing annuity contracts. The age of the relevant life is measured in years, however it may be measured using various other periods of time (i.e. days, weeks, months, decades, etc.) and is illustrated on the x-coordinate of graph 1000. “Guaranteed Benefit” line 1006 illustrates the “normal” or “guaranteed” lifetime benefit payments 1012 under the annuity contract determined by a hypothetical withdrawal percent of 5% (not shown) and a payment base of $100,000. Additionally, “Facility Care Benefit” line 1008 illustrates the enhanced lifetime benefit payments 1010 that are elected by the relevant life starting at age 70 and proceeding for 5 consecutive years until finally terminating. As illustrated by graph 1000 the hypothetical lifetime benefit payments 1010 are increased by a multiple of three when the relevant life is age 70-74. These hypothetical enhanced lifetime benefit payments 1010 provide the relevant life with extra cash while they are confined to a nursing home and have failed to perform at least two of six predetermined activities of daily living. The present invention provides the relevant life with the potential for greater lifetime benefit payments at a time of need.

It is important to note that for the purposes of illustration, the example in FIG. 9 and FIG. 10 illustrates hypothetical lifetime benefit payments that are not actually requested. That is, the contract value is never reduced by lifetime benefit payments because none are taken. The contract value simply tracks the performance of the underlying funds. However, it is important to note that the contract value will be reduced by the amount of each lifetime benefit payment that is taken. In some situations, it is possible that the growth of the contract value from positive fund performance will not outperform the impact of the decrease caused by the election of lifetime benefit payments by the relevant life. Accordingly, there may reach a point in time when the present payment base is greater than the present contract value. It is important to note that the relevant life can elect to request an amount for the lifetime benefit payment that is less then the available amount for each period.

It should be understood that several of the method steps of the present invention require a computer in order to be able to determine the respective values. In other words, a computer is required to use the method of the present invention; that is to say the calculations and appropriate data records must be accomplished by computer. For example, in one embodiment of the present invention, the payment base is related to premium payments by the relevant life. In one embodiment, the lifetime benefit payment is dependent on a selected withdrawal percentage. Although the method and system require an instruction from the relevant life for the withdrawal percent to use for each given year, the instruction does not have to come directly from the relevant life. The instruction may come indirectly by going through the company issuing the contract or other third party or agent. In one embodiment, the predetermined withdrawal percent is based on the age of the relevant life at the time of the first requested lifetime benefit payment. As noted above, in alternative embodiments, the maximum total withdrawal percent for a given payout period may be established by a specific formula, or may be predetermined and is an arbitrary number for any given period.

The annuity commencement date is a date established according to rules, with certain restrictions. The Initial guaranteed death benefit amount is determined in a similar fashion. Preferably, the initial guaranteed death benefit amount is set for calculation purposes. In a preferred embodiment, the initial guaranteed death benefit amount is equal to the payment base.

The lifetime benefit payment is paid periodically, such as yearly, quarterly, monthly, weekly, etc. The lifetime benefit payment withdrawal percent that is requested by the relevant life for a given year may be any amount greater than zero and equal to or less than the maximum total withdrawal percent remaining for the given payout period. The available lifetime benefit payment withdrawal percent that is remaining is determined at the start of each new year. However, the relevant life does not have to elect the highest possible available lifetime benefit payment at any given time. That is, the relevant life may choose how to “spread” the total withdrawal percent that is available for a given payout period between the individual years within the payout period. The value that is requested by the relevant life, if any, for the lifetime benefit payment for a given year will be subtracted from the contract value, but not from the payment base.

Enhanced lifetime benefit payments do not lower the payment base, which preferably determines the amount of the lifetime benefit payment. In one embodiment, the payment base is only reduced when the insured withdraws more than the specified lifetime benefit payment amount allocated under the contract. In another embodiment, the payment base can be increased or stepped up by a percent, in response to growth of the contract value due to sub-account performance. Usually this increase or step-up is not more than ten percent annually. The payment base does not fluctuate as much as the account value, which more closely reflects the rate of return on investment of the premium.

In a preferred embodiment, the relevant life may not request an enhanced lifetime benefit payment withdrawal until after: (i) the expiration of a moratorium period, which is measured from the issue date of the contract; or (ii) the date the relevant life reaches age 70 (or other predetermined age), whichever is later. In one embodiment, such a moratorium period is five years. Any length of time may be selected for the moratorium period. Preferably, the predetermined yearly withdrawal percent is a function of the relevant life's age. In one embodiment, once the first lifetime benefit payment withdrawal is taken, then that withdrawal percent is used to calculate the maximum total withdrawal percent that is available for a given payout period by multiplying that first withdrawal percent by the number of years in the payout period. In another embodiment, the withdrawal percent used to calculate the maximum total withdrawal percent available for a given payout period continues to rise with the relevant life's age, no matter if the relevant life has already begun to take lifetime benefit payments. In another embodiment, the withdrawal percent may either increase or decrease over the term of the annuity. Alternatively, the withdrawal percent may fluctuate over the term of the annuity.

It should be noted that the predetermined withdrawal percents for each year of the relevant life's future age is different than the withdrawal percent that is elected by the relevant life for any given year in any given payout period. As described above, the predetermined withdrawal percents are used in certain embodiments in order to calculate the maximum total withdrawal percent for any given payout period.

The lifetime benefit payment for any given year, if any, is paid in periodic installments throughout the given year, or alternatively, is paid in a single installment during the given year. The withdrawal percent used may fluctuate for each year during any given payout period according to the needs and/or preferences of the relevant life. The number of years in the payout period is in the range of 2 to 20 years, more preferably in the range of 3 to 10 years, and most preferably 5 years. In a preferred embodiment, the number of years of the first payout period for the lifetime benefit payments is the same as the number of years of each subsequent payout period, if any. The yearly predetermined withdrawal percent may be fixed; may increase at the beginning of each subsequent payout period; may decrease at the beginning of each subsequent payout period; or may fluctuate over the term of the annuity.

In a further embodiment, the present method comprises the step of: periodically paying a withdrawal payment during a given payout period, that is in excess of the lifetime benefit payment, to the relevant life from the contract value which decreases each of: the contract value, the payment base, and the guaranteed death benefit amount, and can decrease the contract value below a predetermined minimum contract value.

In another embodiment, the present method further comprises the step of paying a death benefit to a beneficiary upon the death of the relevant life, wherein the death benefit is the greater of: (a) a predetermined guaranteed death benefit amount; and (b) the present contract value. Where an enhanced lifetime benefit payment has been made, the death benefit is equal to the predetermined death benefit minus the enhanced lifetime benefit payments.

Alternatively, the guaranteed death benefit is paid to the beneficiary only if the relevant life dies during the accumulation phase. Preferably, if the contract value reaches a predetermined minimum value, then the contract annuitizes and annuity payments commence. Preferably, the value of the annuity payments, if any, equals the value of the last guaranteed lifetime benefit payment.

In another embodiment, the present invention comprises a deferred annuity contract having a payment base value, a contract value, and lifetime benefit payments, comprising: (i) means for receiving information from a relevant life in order to establish the deferred variable annuity contract; (ii) means for determining a payment base value for the annuity contract; (iii) means for determining a contract value for the annuity contract; (iv) means for determining a death benefit amount; (v) means for receiving lifetime benefit payment withdrawal requests from the relevant life; (vi) means for calculating a lifetime benefit payment for the relevant life which decreases both the contract value and the death benefit amount; (vii) means for calculating an enhanced. lifetime benefit payment if an insured can demonstrate failure to perform at least two of six predetermined activities of daily living and if the insured requires long-term care; wherein the enhanced lifetime benefit payment is equal to a predetermined multiple times the lifetime benefit payment withdrawal and wherein the death benefit is reduced by an amount equal to the enhanced withdrawal payment without reducing the payment base.

In another embodiment, the present invention comprises a system for administering a deferred variable annuity contract during the accumulation phase, the annuity contract having a payment base, a contract value and lifetime benefit payments, the improvement comprising: (i) administrative means for predetermining a series of payout periods, wherein the number of years of each payout period is greater than one year; (ii) administrative means for predetermining a maximum total withdrawal percent for each payout period; and (iii) administrative means for calculating the amount of the lifetime benefit payment withdrawal for each given year within a given payout period that provides a withdrawal percent to use for each given year, wherein the sum of the withdrawal percents from each given year within the payout period is equal to or less than the predetermined maximum total withdrawal percent that is allowed for the given payout period.

In another embodiment, the annuity product includes a step-up provision wherein the payment base is increased in response to positive performance of the underlying investments of the contract for a given period. Preferably, the step-up would take place at the beginning of each new payout period (e.g. every five years).

Other formulas may be utilized to determine the lifetime benefit payment amount, wherein the withdrawal base is related to other values besides the payment base and/or the contract value.

The following description and examples further illustrate the preferred features of the present invention.

Preferably, there is a mandatory moratorium period, which is measured from the issue date of the contract. In one embodiment, the moratorium period is five years. The present method allows several years of withdrawal percents to be clustered together, and providing the enhanced flexibility to select a lifetime benefit payment amount based on the preferences and needs of the relevant life. The annuity contract has a series of payout periods, wherein each payout period has a maximum total withdrawal percent that may not be exceeded. Alternatively, the maximum total withdrawal percent for a given payout period may be exceeded if it is part of the multi-period withdrawal percentage total as described herein. In one embodiment, the maximum total withdrawal percent for any given payout period is calculated as the first year's predetermined yearly withdrawal percent during the payout period times the number of years in the given payout period. It is important to note that, in alternative embodiments, the maximum total withdrawal percent for a given payout period is not established by any specific formula, but rather is predetermined and is an arbitrary number. For example, the maximum total withdrawal percent could be predetermined to be 15% over a three year payout period. In a preferred embodiment, the maximum predetermined yearly withdrawal percent is guaranteed at a predetermined percentage, for example about 10%. Preferably, there is a maximum withdrawal percent for any given year, so that the relevant life cannot take the entire total withdrawal percent for the payout period in a single year. In another preferred embodiment, the maximum withdrawal in a given year is guaranteed at a value between 0% and the maximum withdrawal percent for the withdrawal period. For example, if someone withdraws 15% over three years, the maximum in any single year may be 10%. In another feature of the invention, any withdrawal percent amount that is not taken during a given payout period may be rolled into the next payout period, thereby increasing the available withdrawals for that payout period, if certain restrictions are met. In an alternative feature of the present invention, the product requires asset allocation constraints set by the company issuing the annuity product.

Having thus described the invention in rather full detail, it will be understood that such detail need not be strictly adhered to, but that additional changes and modifications may suggest themselves to one skilled in the art, all falling within the scope of the invention as defined by the subjoined claims.

While the present invention has been described with reference to the preferred embodiment and several alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A data processing system for administering a deferred variable annuity contract during the accumulation phase, the annuity contract having a payment base value, a contract value, and lifetime benefit payments, said system comprising:
a storage device;
a processor coupled to the storage device, the storage device storing modules utilized by the processor for determining a payment base value for the annuity contract, for determining a contract value for the annuity contract, for determining a death benefit amount, for calculating a lifetime benefit payment for the relevant life which decreases both the contract value and the death benefit amount, and for calculating an enhanced lifetime benefit payment.

2. The data processing system of claim 1, wherein the enhanced lifetime benefit payment is calculated if an insured can demonstrate failure to perform at least two of six predetermined activities of daily living and if the insured requires long-term care;
wherein the enhanced lifetime benefit payment is equal to a predetermined multiple times the lifetime benefit payment withdrawal; and
wherein the death benefit is reduced by an amount equal to the enhanced withdrawal payment without reducing the payment base.

3. The data processing system of claim 1, wherein the processor is further used for periodically accepting premium payments from the relevant life which increase the payment base, the guaranteed death benefit amount, and the contract value, if requested to do so by the relevant life.

4. The data processing system of claim 1, wherein the processor is further used for periodically calculating a withdrawal payment, that is in excess of the lifetime benefit payment, to the relevant life from the contract value, which decreases each of: the contract value, the payment base, and the guaranteed death benefit amount.

5. The data processing system of claim 4, wherein calculating a withdrawal payment, that is in excess of the lifetime benefit payment, to the relevant life from the contract value can decrease the contract value below a predetermined minimum contract value, if requested by the relevant life.

6. The data processing system of claim 1, wherein upon the death of the relevant life the processor is further used for calculating a death benefit for a beneficiary, wherein the death benefit is the greater of: (a) a predetermined death benefit amount; and (b) the present contract value.

7. The data processing system of claim 6, wherein if the an enhanced lifetime benefit payment has been made the death benefit for a beneficiary is equal to the predetermined death benefit minus the enhanced lifetime benefit payments.

8. The data processing system of claim 1, wherein the enhanced lifetime benefit payment is available to the relevant life for a maximum number of years.

9. The data processing system of claim 1, wherein the enhanced lifetime benefit payment remains available to the relevant life even if the contract value equals zero.

10. The data processing system of claim 1, wherein following at least one request for an enhanced lifetime benefit payment, the lifetime benefit payment still remains available for future withdrawals.

11. A system for administering a deferred variable annuity contract during the accumulation phase, the annuity contract having a payment base value, a contract value, and lifetime benefit payments, comprising:
a storage device;
a processor coupled to the storage device, the storage device storing modules utilized by the processor, the modules comprising:
i. a first module for receiving information from a relevant life in order to establish a deferred variable annuity contract;
ii. a second module for determining a payment base value for the annuity contract;
iii. a third module for determining a contract value for the annuity contract;
iv. a fourth module for determining a death benefit amount;
v. a fifth module for receiving lifetime benefit payment withdrawal requests from the relevant life; and
vi. a sixth module for calculating a lifetime benefit payment for the relevant life which decreases both the contract value and the death benefit amount.

12. The data processing system of claim 11, and further comprising a seventh module for calculating an enhanced lifetime benefit payment if an insured can demonstrate failure to perform at least two of six predetermined activities of daily living and if the insured requires long-term care;
wherein the enhanced lifetime benefit payment is equal to a predetermined multiple times the lifetime benefit payment withdrawal; and
wherein the death benefit is reduced by an amount equal to the enhanced withdrawal payment without reducing the payment base.

13. The data processing system of claim 12, further comprising an eighth module for calculating a death benefit for a beneficiary upon the death of the relevant life, wherein the death benefit is the greater of: (a) a predetermined death benefit amount; and (b) the present contract value, unless an enhanced lifetime benefit payment has been made, in which case the death benefit is equal to the predetermined death benefit minus the enhanced lifetime benefit payments.

14. A computer implemented data processing method for administering a deferred variable annuity contract during the accumulation phase, the annuity contract having a payment base value, a contract value, and lifetime benefit payments, said method comprising the steps of:
a. determining a present payment base for said annuity contract;
b. determining a contract value for said annuity contract that may change over time;
c. determining a death benefit amount that may change over time;
d. if requested by the relevant life, calculating a lifetime benefit payment for the relevant life which decreases both the contract value and the death benefit amount;
e. if requested by the relevant life and if the relevant life is confined to a nursing home and fails two of six predetermined activities of daily living for a predetermined period, calculating an enhanced lifetime benefit payment;
wherein the enhanced lifetime benefit payment is equal to a predetermined multiple times the lifetime benefit payment; and
wherein the enhanced lifetime benefit payment reduces the death benefit by an amount equal to the enhanced lifetime benefit payment without reducing the payment base.

15. The computer implemented data processing method of claim 14, further comprising the step of: if requested by the relevant life, periodically accepting premium payments from the relevant life which increase the payment base, the guaranteed death benefit amount, and the contract value.

16. The computer implemented data processing method of claim 14, further comprising the step of: if requested by the relevant life, periodically calculating a withdrawal payment, that is in excess of the lifetime benefit payment, to the relevant life from the contract value, which decreases each of: the contract value, the payment base, and the guaranteed death benefit amount, and can decrease the contract value below a predetermined minimum contract value.

17. The computer implemented data processing method of claim 14, wherein both of the following two events must have occurred in order for the relevant life to be eligible for the enhanced lifetime benefit payment:
i. the relevant life has reached age seventy; and
ii. ten years have passed since the issue date of the contract.

18. The computer implemented data processing method of claim 14, further comprising the step of: upon the death of the relevant life, calculating a death benefit for a beneficiary, wherein the death benefit is the greater of: (a) a predetermined death benefit amount; and (b) the present contract value, unless an enhanced lifetime benefit payment has been made, in which case the death benefit is equal to the predetermined death benefit minus the enhanced lifetime benefit payments.

19. The computer implemented data processing method of claim 14, wherein the predetermined multiple is three.

20. The computer implemented data processing method of claim 14, wherein the enhanced lifetime benefit payment is available to the relevant life for a maximum number of years.

21. The computer implemented data processing method of claim 14, wherein the enhanced lifetime benefit payment remains available to the relevant life even if the contract value equals zero.

22. The computer implemented data processing method of claim 14, wherein following at least one request for an enhanced lifetime benefit payment, the lifetime benefit payment still remains available for future withdrawals.
